(19) United States
(12) Patent Application Publication
(10) Pub. No.: US 2009/0083106 A1
(43) Pub. Date: Mar. 26, 2009

(54) Automatically Updating Contingent Events in Electronic Calendar Systems

(75) Inventors: Kulvir Singh Bhogal, Fort Worth, TX (US); Robert Ross Peterson, Austin, TX (US); Lisa Anne Seacat, San Francisco, CA (US)

Correspondence Address: MOLLBORN PATENTS, INC., 2840 COLBY DRIVE, BOULDER, CO, 80305, US

(73) Assignee: International Business Machines Corporation, Armonk, NY (US)

(21) Appl. No.: 11/860,114

(22) Filed: Sep. 24, 2007

(51) Int. Cl. G06Q 10/00; G06F 17/30; G06F 17/40

(52) U.S. Cl. 705/8

(57) ABSTRACT

Methods and apparatus, including computer program products, implementing and using techniques for managing contingent events in an electronic calendar system. A priority is associated with each event among two or more events. The two or more events are at least partly overlapping in the electronic calendar system. When a high priority event of the two or more events is canceled from the electronic calendar system, the high priority event is automatically replaced with a lower priority event from the two or more events.

### BACKGROUND

This invention relates to electronic calendar systems. Electronic calendar systems have become an increasingly common work support tool, both within organizations and for private users. Typically, electronic calendar systems contain functionality for automatically checking electronic calendars of other users, such as members in a work team, for open time slots, proposing alternative meeting times, scheduling team meetings or appointments, and notifying and reminding invitees by email about their upcoming meetings.

Generally, when a user schedules a meeting through an electronic calendar system the scheduled time slot for the meeting becomes unavailable in their calendar for other meeting requests and events. In most cases, this is what the user wants to happen. However, there are also cases where tentative meeting invitees who have received meeting invitations end up not responding to or declining their invitations, and as a result the meeting will not occur. In these situations, the tentative meeting invitees may want to free up the time slot that was originally blocked off for the meeting for other kinds of activities.

In conventional electronic calendar systems, users other than the meeting organizer must cancel their calendar entries through a manual process. Each user who has accepted an invitation for a meeting that will not occur must locate the meeting time slot in their calendar, and manually delete the calendar entry. This process can be both time consuming and frustrating. When the meeting organizer wishes to cancel a meeting, a cancellation notification is typically sent out to the invitees, who can cancel the event by accepting the cancellation notification. That is, the process is somewhat more automated. However, it is clear that there is a need for an improved electronic calendar system that is more user-friendly

### SUMMARY

In general, in one aspect, the invention provides methods and apparatus, including computer program products, implementing and using techniques for managing contingent events in an electronic calendar system. A priority is associated with each event among two or more events. The two or more events overlap at least in part in the electronic calendar system. When a high priority event of the two or more events is canceled from the electronic calendar system, the high priority event is automatically replaced with a lower priority event from the two or more events.

The various embodiments of the invention can include one or more of the following advantages. Users can accept several events in the same time slot on their calendar. For example, one event can be designated as a primary event and be accepted completely and another event can be designated as a secondary event and be accepted tentatively. Events that have been posted to the electronic calendar can be automatically canceled, as simply as adding events, without users having to locate and delete the calendar event manually. If the primary event is cancelled, for example, due to the responses (or lack thereof) to event invitations by certain individuals or by groups of individuals, and/or the availability of resources necessary for the event, such as rooms or various types of equipment needed for the event, the secondary event can be fully accepted and replace the primary event. This can typically occur without any intervention by the user. When the primary event is confirmed, a message declining the invitation can be sent to the organizer of the secondary or tentative event. It is possible to make better user of a user's availability and to avoid unnecessary rescheduling of meetings.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a schematic view of an event creation window in an electronic calendar in accordance with one embodiment of the invention.

FIG. 2 shows a process for scheduling an event with an automatic cancellation feature in accordance with one embodiment of the invention.

FIG. 3 shows a schematic view of a timeslot in an electronic calendar where a user has scheduled several meetings in accordance with one embodiment of the invention.

FIG. 4 shows a process for designating contingent events in accordance with one embodiment of the invention.

FIG. 5 shows a process for updating an electronic calendar in response to an event cancellation in accordance with one embodiment of the invention.

Like reference symbols in the various drawings indicate like elements.

### DETAILED DESCRIPTION

The various embodiments of the invention described herein pertain to enhancements of electronic calendar systems. In particular, a person scheduling an event, such as a meeting, can specify a timeout interval for the invitees of the event. If the invitees who are required to attend the event do not respond within the specified timeout interval, or initially accept the event invitation and subsequently decide to cancel, the event is automatically cancelled. Users may also schedule several events in the same or in overlapping time slots in their calendars, and assign various priorities to the events. When an accepted event with a higher priority gets canceled, the electronic calendar system can automatically replace the canceled event with a tentatively accepted event of lower priority. The priorities for the events can either be automatically assigned or be assigned by the user, as will be discussed in further detail below. Various embodiments of the invention will now be described by way of example of a meeting event, and with reference to the drawings. It should however be realized that the principles described below can be applied to any type of event that can be represented by an entry in an electronic calendar system.

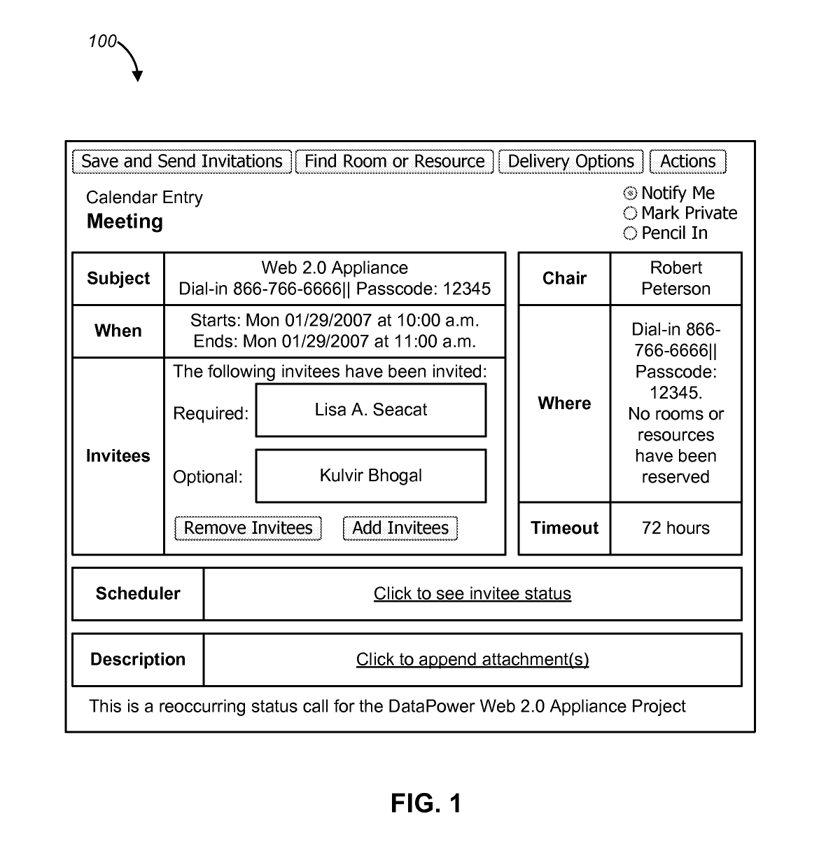

FIG. 1 shows a schematic view of a user interface representing a meeting creation window (100) in an electronic calendar application. The meeting creation window (100) allows a user, herein referred to as a scheduler, to enter information pertaining to an invitation that is to be sent out to a group of people, herein referred to as invitees, about a meeting. As can be seen in FIG. 1, the meeting creation window (100) allows the scheduler to enter information about, for example, the subject of the meeting, when the meeting is scheduled, where the meeting will take place, a time for the meeting, the chair of the meeting, and the invitees of the meeting, similar to conventional electronic calendars.

In the embodiment shown in FIG. 1, the invitees are divided into required invitees and optional invitees. Typically, a required invitee is an individual whose attendance is necessary for the meeting to occur, and an optional invitee is an individual whose attendance is desired but not necessary for the meeting to occur. It should be noted that in other implementations, other categories can be defined in addition to or to replace the “required” and “optional” categories. For example, there may be a “substitute” category of invitees that can receive an invitation to replace an optional invitee who declines the meeting.

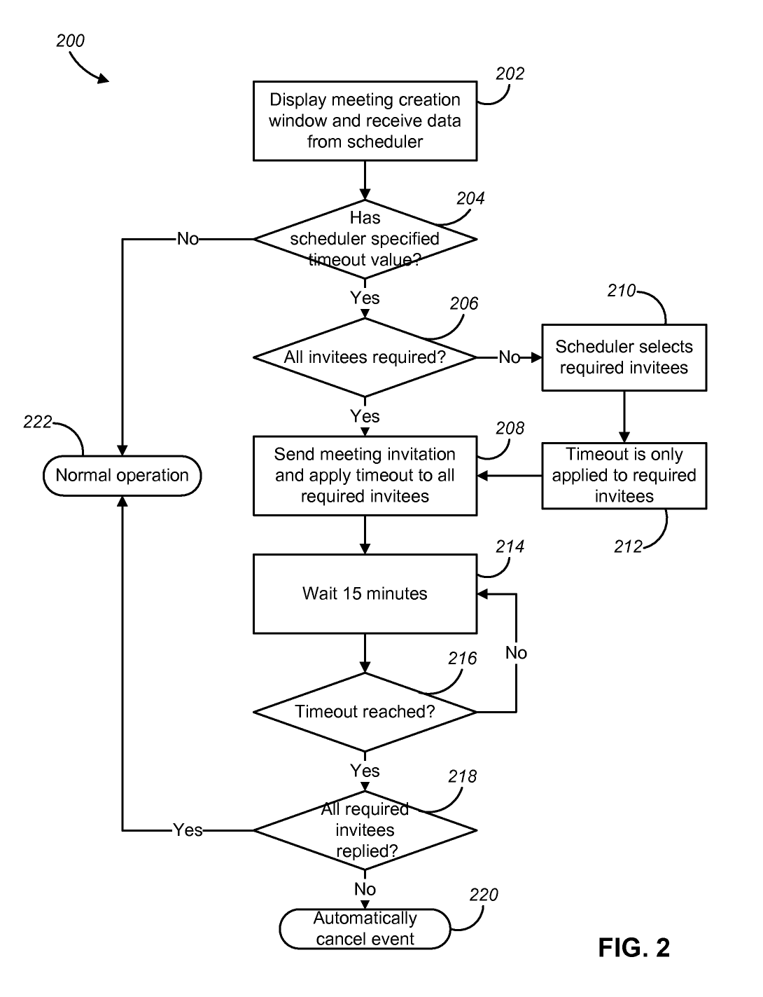

As can be seen in FIG. 1, there is also a timeout value associated with the meeting invitation. In the case illustrated in FIG. 1, the scheduler has specified the timeout value of 72 hours. The timeout value specifies a time period during which the invitees must respond to the invitation. If no response is received within this time period, the meeting will be automatically canceled and removed from the invitees' and the scheduler's calendars, as will be described below in further detail and with reference to FIG. 2. This obviates the need for the invitees and scheduler to manually delete the calendar entry for the meeting from their calendars. It should be noted that in various embodiments, actions other than automatic canceling can occur. For example, if an invitee has not responded within the preset time period, a reminder can be sent to the invitee, in case she lost the first invitation. The note may optionally also be sent to the administrative assistant of the invitee. If no response has been received after a second time period associated with the reminder, then the meeting can be automatically canceled. Thus, the automatic cancellation described below is merely one example of a whole range of possible actions that may be taken when the timeout value expires.

In various embodiments of the invention, the scheduler can also perform additional functions in the meeting creation window (100). Some examples are illustrated in FIG. 1, such as clicking a link to view invitee status, that is, who has responded to the invitation after the invitation was sent out. The scheduler can also, optionally, attach documents, images, or other electronic computer files to the invitation, add notes at the end of the meeting invitation, and see how much time remains for the invitees to respond to the invitation. Many similar variations and options can be realized by those of ordinary skill in the art.

FIG. 2 shows a process (200) for scheduling a meeting with an automatic cancellation feature in accordance with one embodiment of the invention. As can be seen in FIG. 2, the process starts by displaying a meeting creation window (100) as shown in FIG. 1 to the scheduler (step 202), in which the scheduler enters data as described above. The process then checks whether the scheduler has specified a timeout value (step 204). If the scheduler has not specified a timeout value, the process continues to step 222 where normal operation proceeds, i.e., the meeting is added to the invitees' calendars and the invitees typically attend the meeting, similar to conventional electronic calendar systems.

If the scheduler has specified a timeout value in step 204, the process continues by checking whether all invitees are required, or whether there are some required and some optional invitees (step 206). If all invitees are required invitees, the process continues to step 208 where the meeting invitation is sent out to all the required invitees. If the scheduler has specified that there are both required and optional invitees in step 206, the scheduler selects the required invitees (step 210). The process then applies the timeout to the required invitees (step 212), and the meeting invitation is sent out (step 208).

After the meeting invitation has been sent out to the invitees, the process waits for 15 minutes (step 214), or any other suitable length of time depending on the timeout value specified by the scheduler, and then the process checks whether the timeout value has been reached (step 216). If the timeout value has not been reached, the process returns to step 214 and waits another 15 minutes. When the process determines in step 216 that the timeout value has been reached, the process checks whether all the required invitees have replied (step 218). If all the invitees have replied within the specified timeframe, the process continues to step 222 and proceeds with normal operation, similar to conventional electronic calendar systems. If one or more of the required invitees has not replied to the invitation in step 218, then the process cancels the meeting and automatically deletes the meeting entries from the scheduler's and invitees' electronic calendars (step 220) so that the timeslot can be used for other purposes. This ends the process (200).

In some embodiments, a “tentative accept” reply from an invitee (as opposed to a regular “accept”) to the meeting invitation, is treated similar to a non-reply for the purposes of automated meeting cancellation. The reason is that many people tentatively accept a meeting in order to have their information about the meeting in the calendar. On the other hand, a scheduler who receives a tentative accept from a required invitee, must at some point know for sure whether the invitee is planning to attend the meeting or not, and thus the tentative accept cannot be treated as a definite answer as to whether the meeting will go ahead as scheduled or be canceled. It should, however, be noted that the treatment of “tentative accepts” is implementation-specific. There are cases in which tentative accepts can be treated as a regular accept, for example, if the tentative accept comes from an optional invitee, which does not have too big of an impact on whether the meeting will occur or not. Other, alternative, situations can be easily envisioned by those of ordinary skill in the art.

In some embodiments, before the automated cancellation in step 220, the process can optionally notify the required invitees with an automated email, chat message, SMS, or the like that they have one last chance to accept the meeting before the meeting is cancelled. Typically a second, shorter, timeout value is associated with this notification, and if no response is received within this second time period, the meeting is canceled.

In some embodiments, a resource associated with the meeting, such as a meeting room or some type of equipment that has been reserved for the meeting can be freed up based on the automated meeting cancellation in step 220. Thus, the electronic calendar system can communicate with a room reservation or equipment reservation system to automatically free up the meeting room or resource associated with the meeting. The room reservation or equipment reservation system can either be part of the electronic calendar system or be an external system with which the electronic calendar system can communicate.

Furthermore, in some embodiments the meeting scheduler can assign different timeout intervals to different meeting invitees. This allows the scheduler to give extra time to reply to some individuals, which may be useful, for example, when an invitee is traveling and may not have regular access to his electronic calendar. Alternatively, the timeout intervals can be assigned based on seniority within a company. For example, a CEO can be given 72 hours to respond to an invitation, whereas a patent engineer can be given 6 hours to respond to the same invitation.

In some embodiments, instead of completely cancelling the meeting as described above for step 220, which typically requires that the scheduler prepares a new meeting invitation from scratch, the time slots in the invitees' calendars and the rooms and optionally other resources (e.g., projector, catering, etc.) are freed up, while the meeting invitation is returned to the scheduler for revision. This allows the scheduler to make much fewer changes than would typically be involved in creating a completely new meeting invitation from scratch, and then to resend the meeting invitation to the invitees.

In some embodiments, the status of the meeting can be indicated to the invitees. In general, meetings can have two or three status values, such as “proposed,” “confirmed,” “cancelled” and so on. Invitees may want to be able to differentiate between additional states, such as “proposed—pending critical resources” versus “proposed—critical resources committed” and so on. An invitee facing a scheduling conflict may want to revisit a meeting proposal to determine whether the “critical resources” have been committed.

As was discussed above, various embodiments of the invention allow a user to accept multiple event invitations in their electronic calendars and assign different priorities to the events. For example, an event with priority 1 can be a fully accepted event, and other events with priority values 2, 3, 4 . . . and so on can be tentatively accepted events that will replace the accepted event, should the accepted event be canceled, as described above.

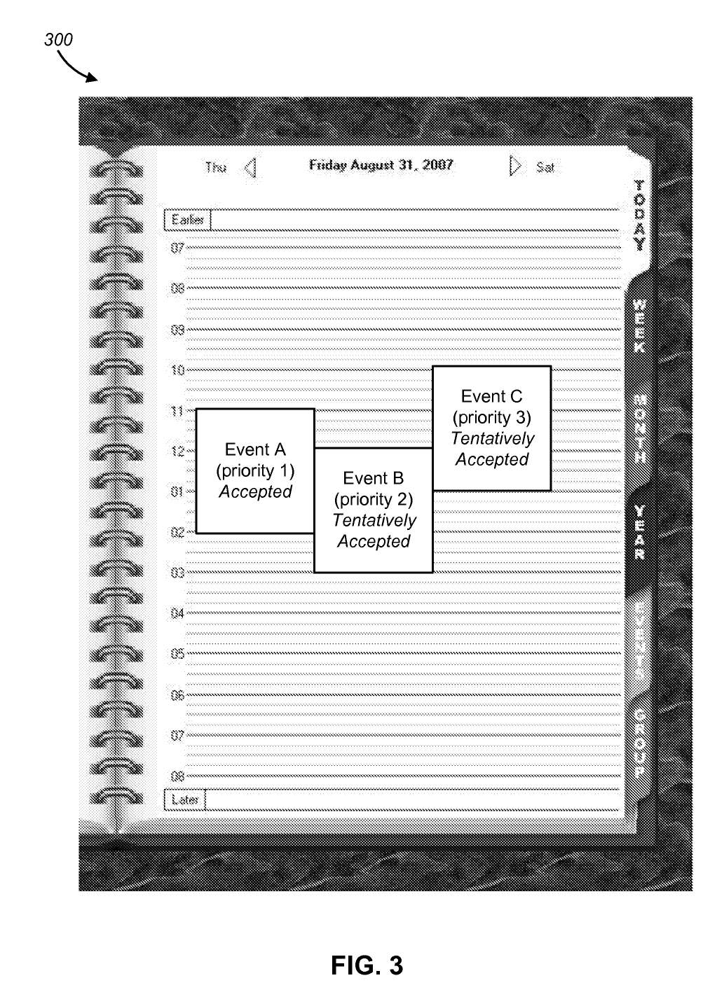

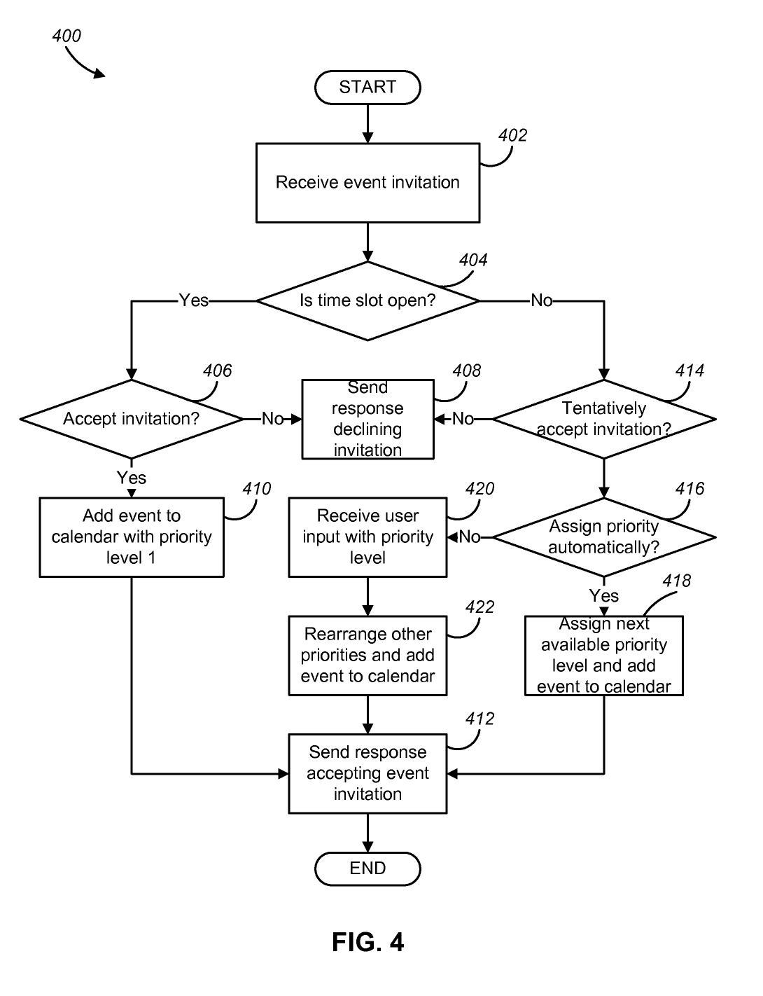

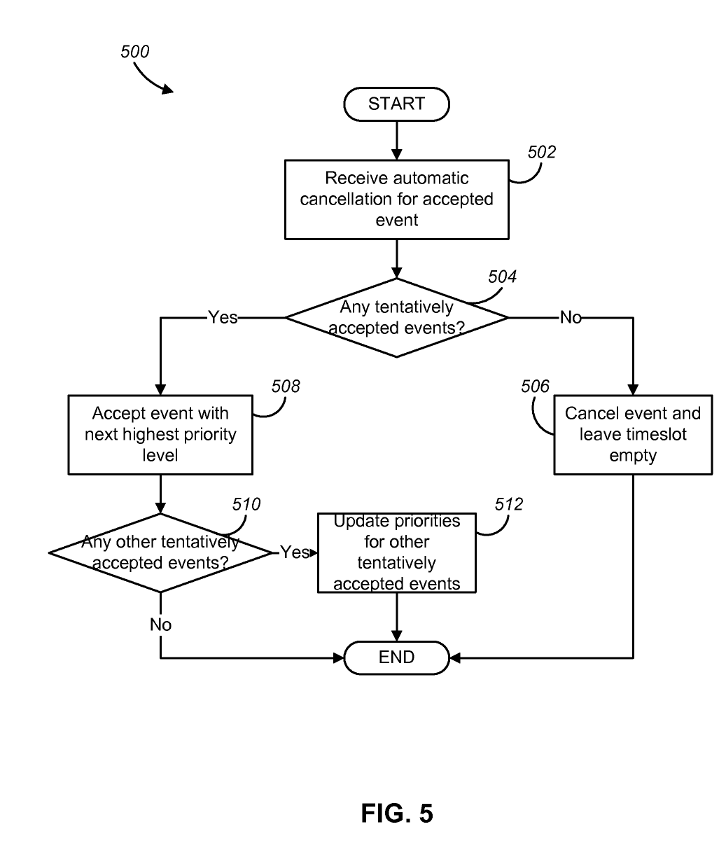

FIG. 3 shows a schematic view of a timeslot in a user's electronic calendar (300) where a user has scheduled several events. As can be seen in FIG. 3, Event A is an event with priority 1 and is marked as “Accepted;” Event B is an event with priority 2 and is marked as “Tentatively Accepted”; and Event C is an event with priority 3 and is marked as “Tentatively Accepted.” Even though Event A, Event B, and Event C do not completely overlap, they have at least some overlapping portions and will therefore be treated as contingent events, as will be described in further detail below with reference to FIGS. 4 and 5.

FIG. 4 shows a process (400) for designating contingent events in accordance with one embodiment of the invention. As can be seen in FIG. 4, the process (400) starts by receiving an event invitation (step 402). Typically, the event invitation is created by a scheduler as was described above with reference to FIG. 2. Next, the process checks whether the timeslot is open in the invitee's electronic calendar (step 404). If the time slot is open, the invitee is asked whether the invitation should be accepted (step 406). In some embodiments, the invitee can also set her calendar to automatically accept invitations if the time slot in question is open. In some embodiments, further limitations can be set, for example, so that no invitations are accepted during the lunch hour between 12-1 p.m., or so that only invitations for the afternoons of business days are accepted, and so on, as can be realized by those of ordinary skill in the art.

If the invitee decides not to accept the invitation, a response is sent to the scheduler in which the invitee declines the invitation (step 408), and the process (400) ends. If the invitee decides to accept the invitation, the invitation is automatically added to the invitee's calendar and is assigned priority level 1 (step 410). A response is sent to the scheduler, in which the invitee accepts the event invitation (step 412), and the process (400) ends.

Now returning to step 404, if the time slot for the event invitation already contains at least one accepted event with priority level 1, and possibly other tentatively accepted events with lower priority levels, the invitee is asked whether to tentatively accept the event invitation (step 414). If the invitee decides not to tentatively accept the invitation, or has pre-configured her calendar to only accept a single invitation per time slot, a response is sent to the scheduler in which the invitee declines the invitation (step 408), as was described above, and the process (400) ends.

If the invitee decides to tentatively accept the invitation in step 414, then a decision is made as to whether automatically assign the priority or let the user specify a priority level (step 416). If the invitee chooses to automatically assign a priority level, then the process continues to step 418, where the next available priority level is assigned to the event and the event is added to the calendar as a tentatively accepted event. Finally, a response is sent to the scheduler, in which the invitee tentatively accepts the event invitation (step 412), and the process ends.

If the invitee chooses to not assign a priority level automatically in step 414, the process continues to step 420, where a user input with a priority level is received for the event (step 420). Then the priorities of the other, tentatively accepted, events are then rearranged based on the user input, and the event is added to the invitee's electronic calendar (step 422). Typically, rearranging the priorities involve inserting the most recent event at a higher place in the priority queue, and “bumping” the lower priorities to a lower level. For example, if there are three events, as shown in FIG. 3, and a fourth event invitation is tentatively accepted and the user assigns priority level 2, then Event B of FIG. 3 will be changed to priority level 3, and Event C will be changed to priority level 4, and so on. Finally, a response is sent to the scheduler, in which the invitee tentatively accepts the event invitation (step 412), as described above, and the process ends.

FIG. 5 shows a process (500) for updating an electronic calendar in response to an event cancellation in accordance with one embodiment of the invention. As can be seen in FIG. 5, the process starts by receiving an automatic cancellation for an accepted event (i.e., a priority 1 event), as described above (step 502). The process then checks whether there are any events scheduled for the same timeslot that have been tentatively accepted (i.e., priority 2 or lower) (step 504). If there are no tentatively accepted events, the process cancels the event and the timeslot is left empty (step 506), as has been described above. This ends the process.

If it is detected in step 504 that there are tentatively accepted events, the process accepts the event that has the next priority level (step 508), that is, a tentative event with priority level 2. Optionally a notification can be sent to the scheduler of this event to inform the scheduler that the event has now changed status from tentatively accepted to fully accepted. The process then checks whether there are any other tentatively accepted events in the same timeslot (step 510). If there are no other events, the process (500) ends. Otherwise, the process updates the priorities for the remaining tentatively accepted events (step 512) before it ends. Typically, this updating includes changing the priority level from 3 to 2, from 4 to 3, and so on, depending on the number of tentatively accepted events in the timeslot.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

A number of implementations of the invention have been described. Nevertheless, it will be understood that various modifications may be made without departing from the spirit and scope of the invention. For example, in some embodiments un-prioritized events can automatically be given a higher priority based on the ability to fit as many meetings into a user's schedule as possible. Assume, for example that a user has scheduled three meetings; one from 1-2 p.m., one from 2-3 p.m., and one from 1:30-2:30 p.m. If the user accepts the 1:30-2:30 p.m. meeting, he will neither be able to attend the 1-2 p.m. meeting nor the 2-3 p.m. meeting, and may be sitting idle for the two unused half hour slots on either end. However, if the user decides to chose the 1-2 p.m. meeting and the 2-3 p.m. meeting, he can attend two meetings and have no downtime. Thus, in some implementations it may be preferable to recommend priorities to the user based on such considerations. Of course, if the 1:30-2:30 p.m. meeting is an important meeting, the user can override the recommendation and choose to give this meeting a higher priority. Furthermore, in some implementations, the priorities can be assigned based on a set of rules. For example, meetings that are scheduled by managers may be assigned higher priorities than meetings that are scheduled by new interns. Accordingly, other embodiments are within the scope of the following claims.

1. A computer-implemented method for managing contingent events in an electronic calendar system, the method comprising:
associating a priority with each event among two or more events, the two or more events being at least partly overlapping in the electronic calendar system; and
in response to canceling a high priority event of the two or more events from the electronic calendar system, automatically replacing the high priority event with a lower priority event from the two or more events.

2. The method of claim 1, wherein associating priority with each event includes receiving a user input assigning a priority to each event among the two or more events.

3. The method of claim 1, wherein associating priority with each event includes automatically assigning a next available priority based on the existing priorities for already scheduled events.

4. The method of claim 1, wherein the event with the highest priority is an accepted event and the events with lower priorities are tentatively accepted events.

5. The method of claim 1, wherein
canceling a high priority event includes canceling the highest priority event; and
replacing the high priority event with a lower priority event includes replacing the highest priority event with an event having the next highest priority.

6. The method of claim 1, further comprising:
updating the priorities on the lower priority events in response to replacing the high priority event.

7. The method of claim 1, further comprising:
sending a message to a scheduler of the lower priority event replacing the high priority event to update the status of the lower priority event from tentatively accepted to accepted.

8. The method of claim 1, wherein canceling the high priority event from the electronic calendar system occurs in response to a timeout associated with an invitation for the high priority event.

9. The method of claim 1, wherein associating a priority with each event among a two or more events is performed based on a set of rules including one or more of: who is the sender of an invitation for the event, maximizing the number of events that can be attended in a given time period, and minimizing the unscheduled time in a given time period.

10. A computer program product comprising a computer useable medium including a computer readable program, wherein the computer readable program when executed on a computer causes the computer to:
associate a priority with each event among two or more events, the two or more events being at least partly overlapping in the electronic calendar system; and
in response to canceling a high priority event of the two or more events from the electronic calendar system, automatically replace the high priority event with a lower priority event from the two or more events.

11. The computer program product of claim 10, wherein associating priority with each event includes receiving a user input assigning a priority to each event among the two or more events.

12. The computer program product of claim 10, wherein associating priority with each event includes automatically assigning a next available priority based on the existing priorities for already scheduled events.

13. The computer program product of claim 10, wherein the event with the highest priority is an accepted event and the events with lower priorities are tentatively accepted events.

14. The computer program product of claim 10, wherein
canceling a high priority event includes canceling the highest priority event; and
replacing the high priority event with a lower priority event includes replacing the highest priority event with an event having the next highest priority.

15. The computer program product of claim 10, further causing the computer to:
update the priorities on the lower priority events in response to replacing the high priority event.

16. The computer program product of claim 10, further causing the computer to:
send a message to a scheduler of the lower priority event replacing the high priority event to update the status of the lower priority event from tentatively accepted to accepted.

17. The computer program product of claim 10, wherein canceling the high priority event from the electronic calendar system occurs in response to a timeout associated with an invitation for the high priority event.

18. The computer program product of claim 10, wherein associating a priority with each event among a two or more events is performed based on a set of rules including one or more of: who is the sender of an invitation for the event, maximizing the number of events that can be attended in a given time period, and minimizing the unscheduled time in a given time period.

19. An electronic calendar system comprising:
means for associating a priority with each event among two or more events, the two or more events being at least partly overlapping in the electronic calendar system; and
in response to canceling a high priority event of the two or more events from the electronic calendar system, means for automatically replacing the high priority event with a lower priority event from the two or more events.

20. The electronic calendar system of claim 19, wherein the means for associating priority with each event includes means for receiving a user input assigning a priority to each event among the two or more events.

21. The electronic calendar system of claim 19, wherein the means for associating priority with each event includes means for automatically assigning a next available priority based on the existing priorities for already scheduled events.

22. The electronic calendar system of claim 19, wherein the event with the highest priority is an accepted event and the events with lower priorities are tentatively accepted events.

23. The electronic calendar system of claim 19, wherein
the means for canceling a high priority event includes means for canceling the highest priority event; and
the means for replacing the high priority event with a lower priority event includes means for replacing the highest priority event with an event having the next highest priority.

24. The electronic calendar system of claim 19, wherein canceling the high priority event from the electronic calendar system occurs in response to a timeout associated with an invitation for the high priority event.

25. The electronic calendar system of claim 19, wherein associating a priority with each event among a two or more events is performed based on a set of rules including one or more of: who is the sender of an invitation for the event, maximizing the number of events that can be attended in a given time period, and minimizing the unscheduled time in a given time period.
